(19) United States
(12) Patent Application Publication
(10) Pub. No.: US 2016/0019321 A1
(43) Pub. Date: Jan. 21, 2016

(54) SYSTEM, COMPUTER PROGRAM, AND METHOD FOR DESIGNING CUSTOM BUILDING COMPONENTS

(71) Applicant: A. Zahner Company, Kansas City, MO (US)

(72) Inventors: L. William Zahner, Kansas City, MO (US); Craig Long, Lawrence, KS (US); Dylan Barr, Kansas City, MO (US)

(73) Assignee: A. Zahner Company, Kansas City, MO (US)

(21) Appl. No.: 14/735,842

(22) Filed: Jun. 10, 2015

Related U.S. Application Data
(60) Provisional application No. 62/016,180, filed on Jun. 24, 2014.

(51) Int. Cl. G06F 17/50

(52) U.S. Cl. CPC G06F 17/5004

(57) ABSTRACT

A system and method for designing, visualizing, pricing, and generating specifications for custom building components to be installed onto a structural surface such as an outer wall of a building. The system may be a web server accessible by a web browser and having a computer program stored thereon for accessing information related to building components from a database. The computer program may also receive from a user a selection of a type of building component to customize from the database, as well as surface parameters for the structural surface and user-selected parameters to be applied to a building component of the selected type. The computer program may display a visual depiction and a cost of the building component having the user-selected parameters. The computer program may also generate specifications for fabricating and installing the building component having the user-selected parameters.

### RELATED APPLICATIONS

This application claims priority benefit of a provisional application entitled, “System, Computer Program, and Method for Designing Custom Building Components,” Ser. No. 62/016,180, filed Jun. 24, 2014 and incorporated by reference herein in its entirety.

### BACKGROUND

Many buildings have facades made of decorative components attached to one or more of their outer or inner walls. The decorative building components can be mounted to protrude from structural surfaces of the buildings and may require anchoring systems with braces for structural support. Facades may include a series of identical building components or components of varying sizes and shapes to create an asymmetrical design. The building components may also be bent, twisted, scored, cut, or otherwise manipulated to create a truly custom design, sometimes referred to as a “cloud wall.”

Designing, fabricating, and installing a facade can be complicated and time-consuming, even for a skilled designer. Numerous factors must be considered when designing a facade, including the number and size of the building components, the materials used, the amounts of material used, types of manipulations required, manpower required for manufacture, etc. All of these factors can greatly affect the final cost of a façade. Thus, designers are often not fully aware of the cost of a façade before submitting the proposed design to manufacturers to receive quotes. If received quotes are too high, designers often must often start the whole design process over.

Designers are also often unaware of manipulation limits for some materials and/or the number and type of braces required for a particular design. Thus, a proposed façade design may require design edits by the manufacturer to make the design feasible for production, which can again add to the time and cost for the façade and change its desired appearance.

### SUMMARY

Embodiments of the present invention solve the above-mentioned problems and provide a distinct advance in the art of designing building facades and other custom building component design. Specifically, embodiments of the present invention provide a system, method, and computer program for designing, simulating, pricing, and generating specifications for custom building components such as facades.

One embodiment of invention is a computer program that permits a user to design custom building components to be mounted to a structural surface. The computer program may access information related to building components from a database, receive from the user a selection of a type of building component from the database to customize, and receive from the user parameters to be applied to a building component of the selected type.

The computer program may then display a visual depiction of the building component having the user-selected parameters. Additionally or alternatively, the computer program may receive structural surface parameters and display a visual depiction of the building components attached to the structural surface having those surface parameters.

The computer program may also determine and display a cost of the building component having the user-selected parameters and generate specifications for the building component having the user-selected parameters. The specifications may include information to manufacture and/or install the building component having the user-selected parameters. As the user adjusts parameters applied to the building components, the computer program may automatically update the cost and/or specification so that the user may see how certain design changes affect the price and/or specification of a custom building component in substantially real time.

Another embodiment of the invention is a computer-implemented method for permitting a user to design custom building components to be mounted to a structural surface. The method may include the steps of accessing information related to building components from a database and receiving from the user a selection of a type of building component from the database to customize or a selection of a previously-designed configuration of custom building components to edit. The method may further include the steps of receiving structural surface parameters for applying to the structural surface, receiving other user-selected parameters from the user for applying to the building components, and displaying a visual depiction of the building components with the user-selected parameters attached to the structural surface having the received structural parameters. The method may further include a step of determining and displaying a cost of the building components having the user-selected parameters and generating specifications for the building components having the user-selected parameters. The specifications may include information to manufacture and install the building components. The method may also include a step of determining a type, location, and quantity of braces required for attaching the building components having the user-selected parameters to the structural surface, and the cost quote and specifications may include information regarding the braces.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of an exemplary building with example custom building components designed in accordance with an embodiment of the present invention;

FIG. 2 is a close-up perspective view of fins and braces of the custom building components of FIG. 1;

FIG. 3 is a schematic view of a computer system that may be used to implement aspects of the present invention;

FIG. 4 is a schematic view of an electronic device that may be used to implement aspects of the present invention;

FIG. 5 is a screen shot in a web browser presenting a first menu and a visual depiction of customizable building components having a ripple configuration displayed by a computer program associated with the system of FIG. 3;

FIG. 6 is another screen shot in the web browser presenting a second menu and the building components of FIG. 5 manipulated to have a sinusoidal configuration and to change the length of the fins;

FIG. 7 is another screen shot in the web browser presenting a third menu and the building components of FIG. 5 manipulated using control points;

FIG. 8 is another screen shot in the web browser presenting a fourth menu and the building components of FIG. 5 manipulated according to a user-selected wave configuration;

FIG. 9 is another screen shot in the web browser presenting a fifth menu and the building components of FIG. 5 manipulated according to a user-selected intersecting wave configuration;

FIG. 10 is another screen shot in the web browser presenting user options for zooming, panning, and rotating the visual depiction of the building components of FIG. 5;

FIG. 11 is another screen shot in the web browser presenting a two-dimensional view of the building components of FIG. 5; and

FIG. 12 is a flow chart illustrating a method of designing, visualizing, pricing, and generating specifications of custom building components in accordance with an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention is intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the present invention is defined only by claims presented in subsequent regular utility applications, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, step, etc. described in one embodiment may also be included in other embodiments, but is not necessarily included. Thus, the present technology can include a variety of combinations and/or integrations of the embodiments described herein.

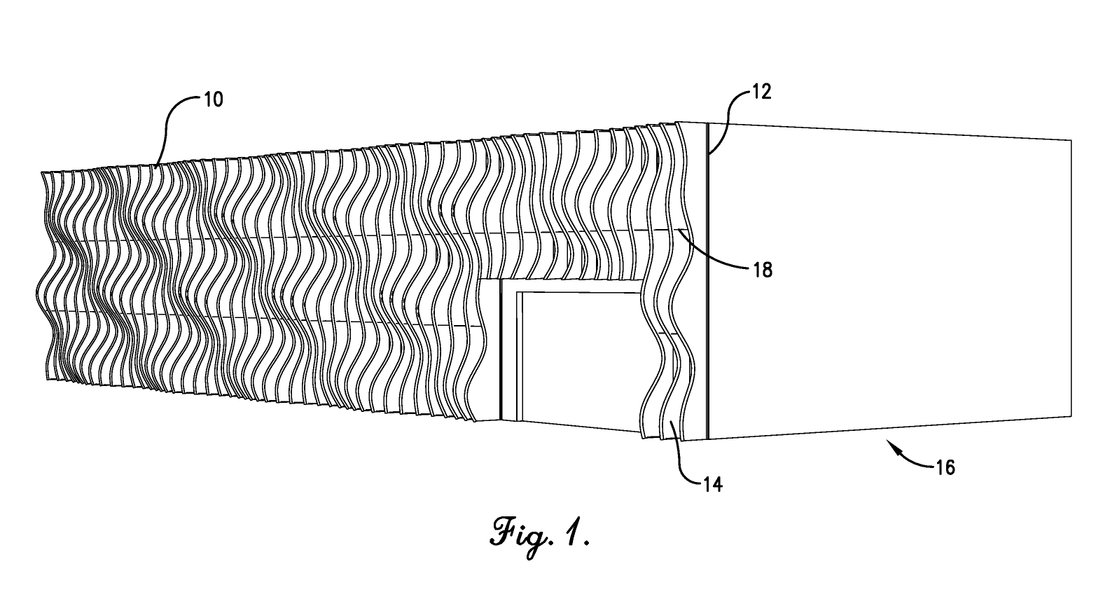

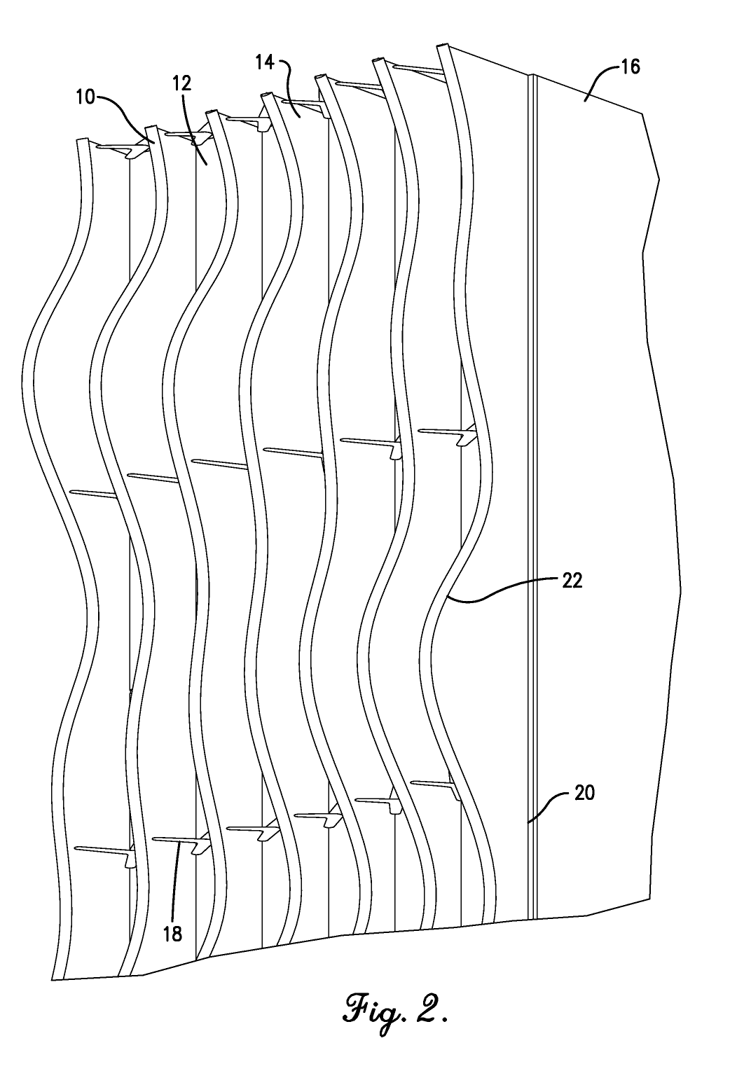

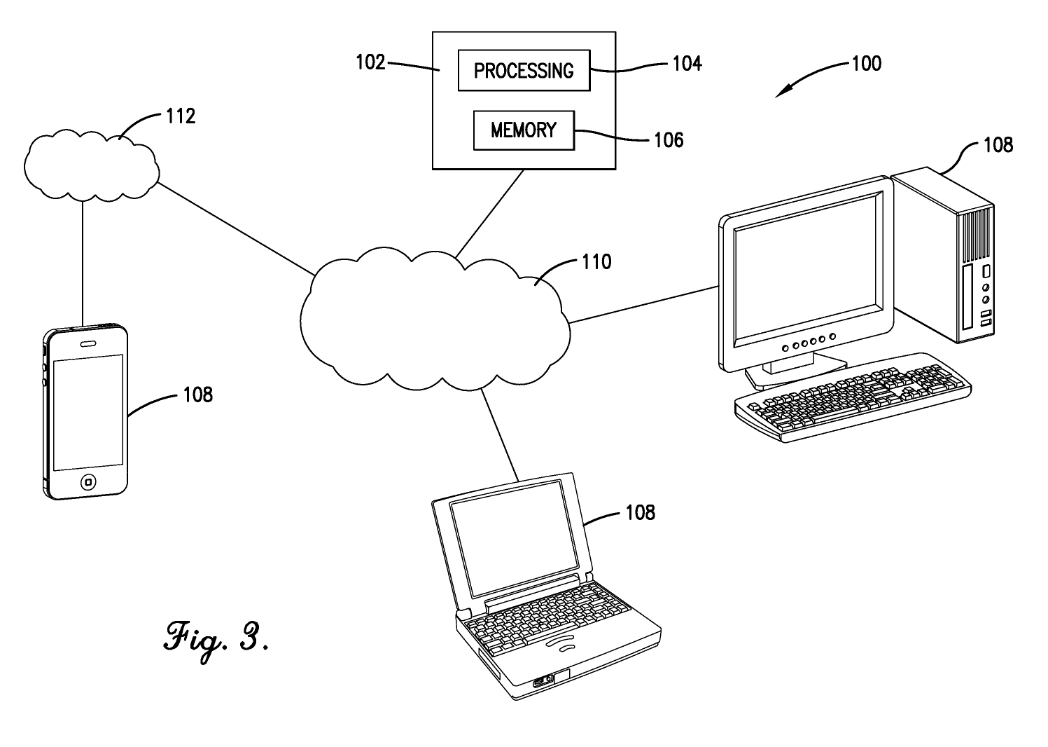

Embodiments of the present invention include a system, computer program, and method for designing custom building components 10, such as building facades, as illustrated in FIGS. 1 and 2. Aspects of the invention may be implemented with a computer system 100, as illustrated in FIG. 3, and a computer program that operates on components of the system 100 for allowing a user to design, visualize, price, and generate specifications for the custom building components 10 in substantially real time via a web portal. The system 100 and associated computer program described herein may be used for any custom building components attachable to any structural surface.

The term “building components,” as used herein, refers to any solid body or component for attachment to any structure, as described below. The custom building components 10 may be, for example, custom fins for attachment to a wall (as described below), glass and metal framing for store fronts and curtain walls, image walls with images punched into metal to create a design, custom tables tops and/or table legs, column covers, doors, hand rails, and the like. In some embodiments of the invention, as illustrated in FIGS. 1 and 2, the custom building components 10 may be attached to a structural surface 12 to form “cloud walls” or other building facades. Cloud walls are broadly defined herein as a series of fins 14 each mounted to the structural surface 12 to form an architectural design on the structural surface 12. The structural surface 12 may be, for example, an outer wall of a building 16, a surface of a railing, a table, or any solid body known in the art. The fins 14 may be rigid and have a length substantially greater than their thickness and width. The fins 14 may be spaced a selected distance apart from each other and anchored to the structural surface 12 and/or structurally supported by various braces 18. The fins 14 and braces 18 may be constructed of a variety of materials, such as various types of woods, plastics, glass, or metals. For example, the fins 14 and/or braces 18 may be formed of mill finished aluminum or painted aluminum of any color.

The fins 14 may each have an inner-most edge 20 positioned closest to the surface 12 and an outer-most edge 22 opposite of the inner-most edge 20 and having a selected shape or curvature. Selected degrees of curvature as well as selected quantity and spacing of curves formed in the outer-most edge 22 of each of the fins 14 may be selected such that the series of fins 14, when mounted on the surface 12, together present a desired design, as illustrated in FIG. 1. The ways in which the fins 14 are shaped and manipulated affect the cost for fabricating and installing the cloud wall. Furthermore, the type of materials selected as well as the depths, lengths, and widths of the fins 14 and the amounts of spacing between adjacent fins 14 may affect the overall cost, design, and appearance of the cloud wall.

In some embodiments of the invention, the structural surface 12 may comprise or have attached thereto custom wall paneling (not shown). The custom wall paneling may be formed of multiple wall paneling pieces or a single wall paneling sheet, depending on the size, shape, and material of the custom wall paneling selected. The wall paneling may be made of a variety of materials, such as wood, glass, plastic, or metal. For example, the wall paneling may be made of stainless steel, zinc, aluminum, etc. However, the structural surface 12 may be any structural surface, such as a table top, roof, wall, railing, etc. without departing from the scope of the invention.

FIG. 3 illustrates an embodiment of the computer system 100 that may be used to implement aspects of the invention discussed herein. The computer system 100 includes a web server or other computer 102 having a processing device 104 and memory 106. The computer 102 may be configured for implementing the computer program and code segments described herein. The computer 102 may be accessed by one or more electronic devices 108 via a communications network 110 or a wireless network 112.

The computer 102 receives, stores, and provides access to the data and information described herein. The computer 102 may also implement one or more computer programs for performing some of the functions described herein and may provide a web-based portal that can be accessed by the electronic devices 108 and other such electronic devices. The computer programs may comprise listings of executable instructions for implementing logical functions in the processing device 104 and/or the electronic devices 108 and can be embodied in any non-transitory computer-readable medium, such as the memory 106, for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

In some embodiments, the computer 102 may reside in a personal computer or server that is accessible by remote users via the Internet or other wired or wireless communication techniques. Embodiments of the computer 102 may include one or more servers running Windows; LAMP (Linux, Apache HTTP server, MySQL, and PHP/Perl/Python); Java; AJAX; NT; Novel Netware; Unix; or any other software system. The computer 102 may also include conventional web hosting operating software, searching algorithms, an Internet connection, and is assigned a URL and corresponding domain name so that it can be accessed via the Internet in a conventional manner. In other embodiments, the computer 102 may be a personal computer, laptop, or any computing device operable to store information and execute software or computer codes associated with the procedures described herein.

The processing device 104 provides processing functionality for the computer 102 and may include any number of processors, microcontrollers, or other processing systems, and resident or external memory for storing data and other information accessed or generated by the computer 102. The processing device 104 may execute one or more computer programs that implement the techniques, code segments, or software modules described herein. The processing device 104 is not limited by the materials from which it is formed or the processing mechanisms employed therein and, as such, may be implemented via semiconductor(s) and/or transistors (e.g., electronic integrated circuits (ICs)), and so forth.

The memory 106 may be any device-readable storage media that provides storage functionality to store various data associated with the operation of the computer 102, such as the computer programs and code segments mentioned above, or other data to instruct the processing device 104 and other elements of the computer 102 to perform the techniques described herein. Although a single memory 106 is shown, a wide variety of types and combinations of memory may be employed. The memory 106 may be integral with the processing device 104, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth.

The memory 106 of the web server or computer 102 stores computer programs and computer code segments as described herein. The memory 106 may also receive and/or store custom building component parameters, such as dimensions, shapes, type and amount of manipulation to be applied to a selected component, locations of manipulation applied, mounting orientation of the building components 10 or fins 14 on the structural surface 12, types of materials, manipulation limits of each material, cost information, etc. Types of manipulation may include bending, cutting, perforating, and the like. The amount of manipulations applied may refer to a how many times a type of physical manipulation is applied to a component (e.g., quantity of bends) or a degree of physical manipulation applied to the component (e.g., curvature or angle of bend). The memory 106 may also store strength, load, and bend limits of each of the materials used for the fins 14, the braces 18. The memory 106 may also receive and store structural surface parameters, such as dimensions of the structural surface 12, locations on the structural surface 12 where the building component 10 is to be mounted, materials and tolerances of the structural surface 12, etc.

The electronic devices 108 may be any electronic processing devices used by users for sending and/or receiving visual surface, building, and materials data and other information described herein. The electronic devices 108 may be desktop computers, laptop computers, tablet computers, portable navigation devices (PND), mobile phones, personal digital assistants, multimedia devices, media players, game devices, combinations thereof, and so forth. Each electronic device 108 preferably includes or can access an Internet browser and a conventional Internet connection such as a wireless broadband connection, DSL converter, or ISDN converter so that it can exchange data with the web server or computer 102 via the communications network 110. One or more of the devices 108 may also exchange data with another one of the devices 108 via a wired or wireless data link as illustrated.

The communications network 110 may be the Internet or any other communications network such as a local area network, a wide area network, or an intranet. The communications network 110 may include or be in communication with a wireless network 112 capable of supporting wireless communications such as the wireless networks operated by AT&T, Verizon, or Sprint. The wireless network 112 may include conventional switching and routing equipment. The communications network 110 and wireless network 112 may also be combined or implemented with several different networks.

The networks 110 and 112 described above are representative of a variety of different communication pathways and network connections which may be employed, individually or in combinations, to communicate among the components of the system 100. Thus, the networks 110 and 112 may be representative of communication pathways achieved using a single network or multiple networks. Further, the networks 110 and 112 are representative of a variety of different types of networks and connections that are contemplated including, but not limited to: the Internet; an intranet; a satellite network; a cellular network; a mobile data network; wired and/or wireless connections; and so forth.

Examples of wireless networks include, but are not limited to: networks configured for communications according to: one or more standard of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth.

The components of the system 100 illustrated and described herein are merely examples of equipment that may be used to implement embodiments of the present invention and may be replaced with other equipment without departing from the scope of the present invention. Some of the illustrated components of the system 100 may also be combined and/or omitted.

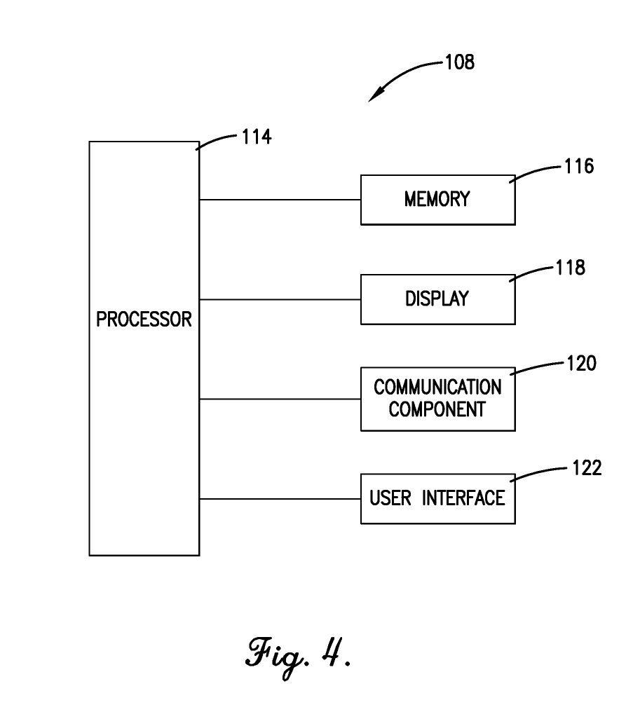

FIG. 4 illustrates one of the electronic devices 108 in more detail. Specifically, the electronic device 108 is operable to provide surface manipulation functionality to a user thereof using various components of the system 100 illustrated in FIG. 3 and described herein. The electronic device 108 may be configured in a variety of ways. For instance, the electronic device 108 may be configured for opening a web portal and/or accessing a web site and associated database for designing, visualizing, pricing, and creating a specification for custom building components. In the following description, a referenced component, such as electronic device 108 may refer to one or more entities, and therefore by convention reference may be made to a single entity (e.g., the electronic device 108) or multiple entities (e.g., the electronic devices 108, the plurality of electronic devices 108, and so on) using the same reference number.

The electronic device 108 is illustrated as including a processor 114 and a memory 116. The processor 114 provides processing functionality for the electronic device 108 and may include any number of processors, microcontrollers, or other processing systems, and resident or external memory for storing data and other information accessed or generated by the electronic device 108. The processor 114 may execute one or more software programs that implement the methods and code segments described herein. The processor 114 is not limited by the materials from which it is formed or the processing mechanisms employed therein and, as such, may be implemented via semiconductor(s) and/or transistors (e.g., electronic integrated circuits (ICs)), and so forth.

The processor 114 may include or have access to a browser. The browser enables the electronic device to display and interact with content such as a webpage within the World Wide Web, a webpage provided by a web server in a private network, and so forth. The browser may be configured in a variety of ways. For example, the browser may be configured as an application stored in the memory 116 and accessed by the processor 114. The browser may be a web browser suitable for use by a full resource device with substantial memory and processor resources (e.g., a personal computer, laptop, electronic tablet, a smart phone, a personal digital assistant (PDA), etc.).

The memory 116 may be any device-readable storage media that provides storage functionality to store various data associated with the operation of the electronic device 108, such as the software program and code segments mentioned above, or other data to instruct the processor and other elements of the electronic device to perform the methods described herein. Although a single memory is shown, a wide variety of types and combinations of memory may be employed. The memory 116 may be integral with the processor, stand-alone memory, or a combination of both. The memory 116 may include, for example, removable and non-removable memory elements such as RAM, ROM, Flash (e.g., SD Card, mini-SD card, micro-SD Card), magnetic, optical, USB memory devices, and so forth.

The electronic device 108 also includes a display 118 to display information to a user of the electronic device 108. In some embodiments of the invention, the display 118 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display 118 may be backlit via a backlight such that it may be viewed in the dark or other low-light environments. In some embodiments of the invention, the display 118 may not be integrated into the electronic device 108 and may instead be connected externally using universal serial bus (USB), Ethernet, serial connections, and so forth. In some embodiments of the invention, the display 118 may be provided with a touch screen to receive input (e.g., data, commands, etc.) from a user. For example, a user may operate the electronic device 108 by touching the touch screen and/or by performing gestures on the screen. In some embodiments, the touch screen may be a capacitive touch screen, a resistive touch screen, an infrared touch screen, combinations thereof, and the like.

The electronic device 108 may also include a communication component 120 configured for enabling one way or two way communication between the electronic device 108 and the web server or computer 102. The communication component 120 may permit the electronic device 108 to send/receive data between different devices (e.g., components/peripherals) and/or over the one or more networks 110 and 112 described above. The communication component 120 may include, for example: one or more antennas; a transmitter and/or receiver; a wireless radio; data ports; networking interfaces; data processing components; and so forth. For example, the communication component 120 may communicate via one or more of the networks 110,112 described above, with a cellular provider and an Internet provider to receive mobile phone service and various content, respectively.

The electronic device 108 may additionally include a user interface 122 communicably coupled with the processor 114. The user interface 122 may be configured for operation by the user to make user selections for viewing and manipulating the custom building components 10, as later described herein. The user interface 122 may comprise one or more functionable inputs such as buttons, switches, scroll wheels, keyboards, touch screen associated with the display 118, voice recognition elements such as a microphone, pointing devices such as mice, touchpads, tracking balls, styluses, a camera such as a digital or film still or video camera, combinations thereof, etc. The user interface 122 may also include an optional speaker for providing audible instructions and feedback.

The above described computer system 100 and associated computer program may be used to design and visualize the custom building components 10 and provide for simple adjustment of user-selectable parameters of the custom building components 10. The system and computer program may also automatically determine how adjusting these parameters will affect the price of manufacture and/or installation. Based on the user-selected parameters, the system and computer program may further create specifications for use by machinery, engineers, manufacturers, and/or installers of the custom building components 10.

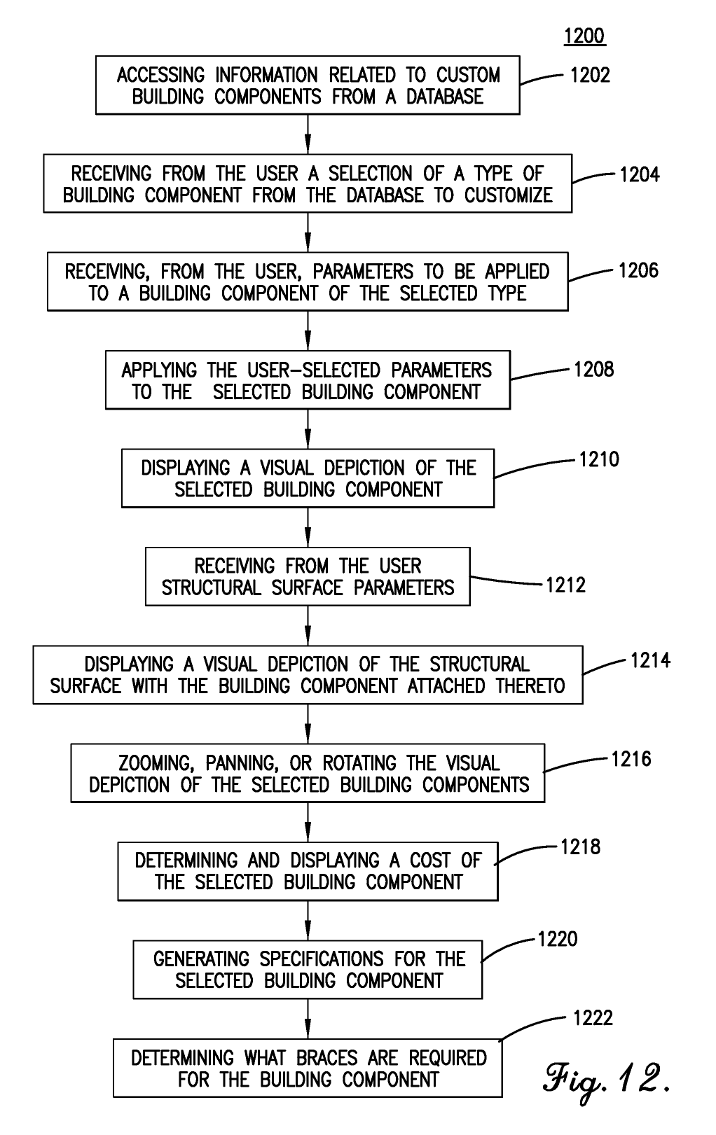

The flow chart of FIG. 12 depicts the steps of an exemplary method 1200 for designing, visualizing, pricing, and generating specifications for custom building components. In some embodiments of the invention, at least a portion of the method steps depicted in FIG. 12 may represent code segments executable by the system 100, the processing device 104, and/or any of the electronic devices 108 described above. In some alternative implementations, the functions noted in the various blocks may occur out of the order depicted in FIG. 12. For example, two blocks shown in succession in FIG. 12 may in fact be executed substantially concurrently, or the blocks may sometimes be executed in the reverse order depending upon the functionality involved.

The method 1200 may include the step of accessing information related to custom building components 10 from a database accessible by the web server or computer 102, as depicted in block 1202. The database may be, for example, stored in the memory 106, and may comprise various custom building component parameters and rules, as noted above. For example, the database may comprise material type, material specifications, material options, and associated cost information. Cost information may include cost of materials and manufacturing processes including gross margin and overhead recover costs and packaging and shipping parameters for eventual delivery of the custom building components. The database may further comprise raw material to be used in manufacturing the custom building components 10 as limited by available commercial size, structural criteria as determined by stress and strain limitations of the chosen materials, and attachment and interface conditions of the custom building components to other structures. The database may also comprise fasteners and other subcomponents needed but not necessarily defined by the user, placement and spacing of these subcomponents, and material finishes selectable by the user. Furthermore, the database may comprise costs associated with different types, amounts, and locations of manipulation of the materials; manipulation limits of each material; and/or types of equipment required for different types of manipulations to different types of materials. The database may also comprise information regarding time, manpower, and machinery required for particular types of manipulation of particular types of materials. Again, types of manipulation may include bending, cutting, perforating, and the like. The database may also store strength, load, and bend limits of each of the materials used for the fins 14 and the braces 18 or other custom building components. Furthermore, the database may store algorithms for calculating the cost of a particular cloud wall design or other custom design based on information stored in the database and user-selected parameters, as described below.

In general, the rules stored in the database may be parametric in nature, setting scope limits for a processor and/or component and controlling how the process or component interrelates to other components needed to manufacture the custom building components 10. The rules and/or algorithms accessed or created by the system 100 and associated computer program may define measurable factors of the custom building components 10 selected or created by the user, and then display this in a three-dimensional interpretation on the display 118. The algorithm may determine a set of criteria, establishing real-time information that is measurable and calculable and a set of conditions of the manufacture of the individual custom building components 10. For example, some algorithms or code segments of the computer program described herein may dictate rules for material specification, rules for vendor of the raw materials, rules for packaging dimensions and materials needed, rules for manufacturing process to be utilized, rules or maintenance information on the materials chosen, rules regarding auxiliary components to be used in manufacture, and the like.

The method 1200 may also include the step of receiving from the user a selection of a type of building component from the database to customize 1204. This step may be performed with the electronic device 108 via the user interface 122 and/or the communication component 120. Specifically, the user may select the type of building component to customize. For example, the user may open a web browser on a computer, enter a web address associated with the computer program described herein, and provide a selection of a type of building component to be customized, such as a cloud wall, a fin, a series of fins, a rail, a table, a deck, or any other type of building component stored in the database. Additionally or alternatively, the user may select a previously saved design to edit, share, order, etc. The previously saved design may be the user's own creation or may be one of a plurality of cloud wall designs stored in the database to be used and/or manipulated by any users.

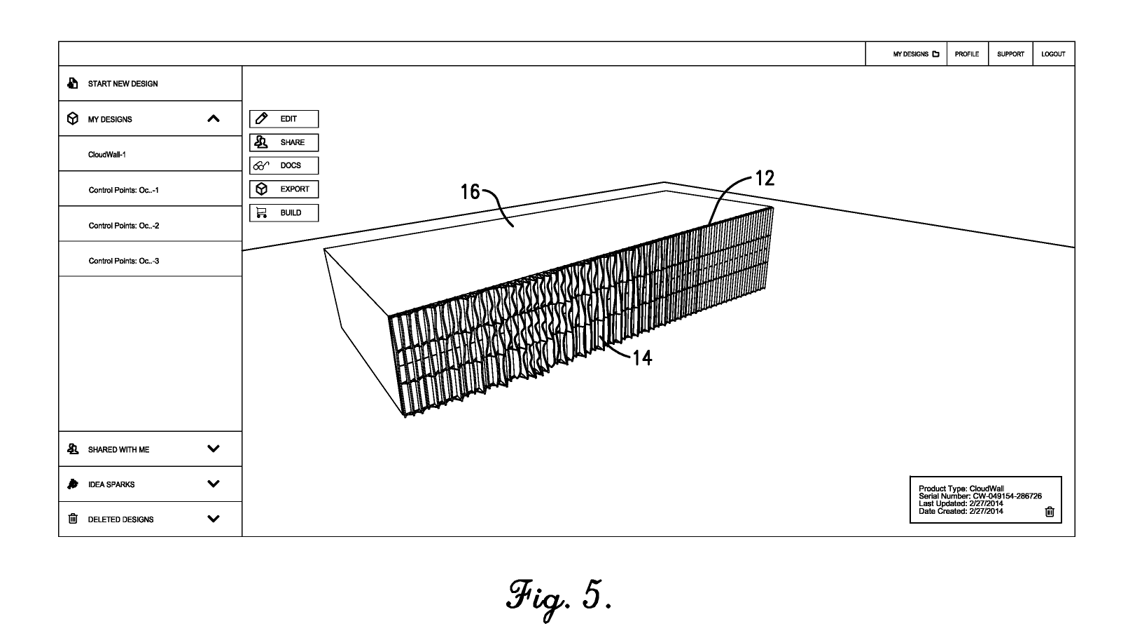

Upon selection of a type of building component to customize (or a previously-saved building component design), a graphical representation of at least one building component of the selected type may be automatically presented on the screen. For example, as illustrated in FIG. 5, a plurality of fins laterally spaced apart may be presented on one wall of a graphical representation of a rectangular building, along with a plurality of braces.

As illustrated in FIG. 5, selection of the type of building component or a previously saved design may cause a menu of options to appear. The menu may include options to edit the fins, share the design with others, export a three-dimensional model file (e.g., .stp, .igs, etc.) of the fins and braces, export documents including detailed specifications and/or engineering two-dimensional drawings of the fins and/or braces, or build the cloud wall by submitting an order via the web page associated with the computer program. The order may include an exchange of funds or an agreement to provide payment in return for agreement to manufacture and/or install the fins and braces.

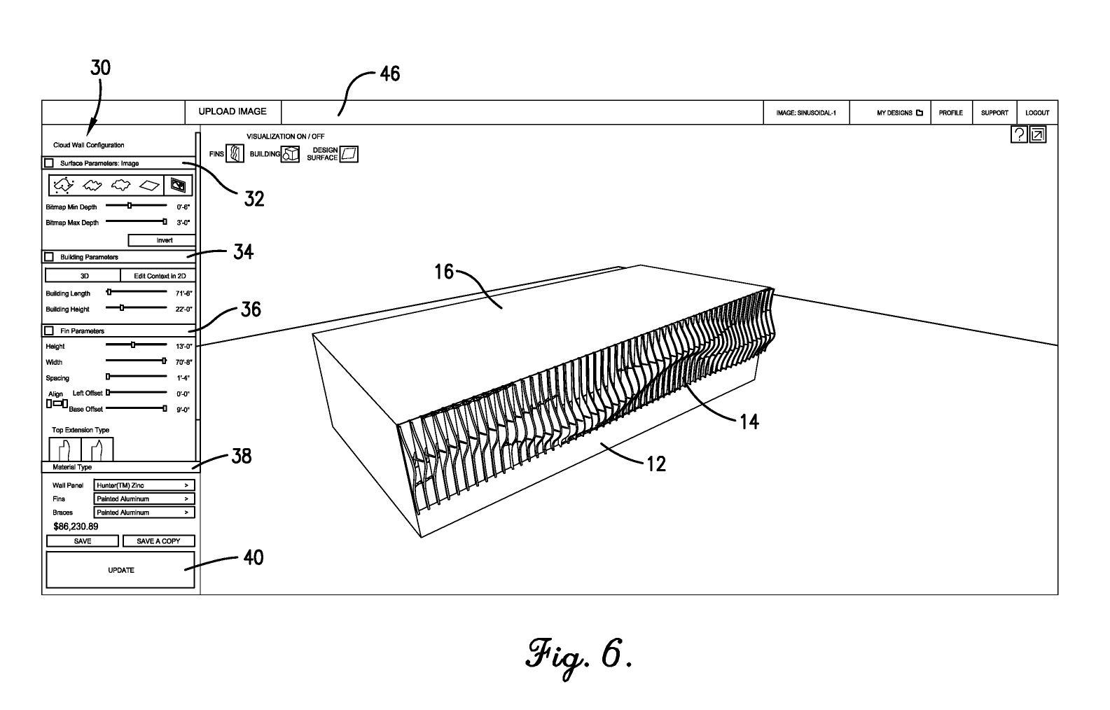

When the user selects to edit the building components or fins, the method 1200 may include the step of receiving, from the user, parameters to be applied to the selected and displayed building components, as depicted in block 1206. User parameters may be adjusted via a user parameter menu 30, illustrated on a left-hand side of the display 118 in FIGS. 6-11, and a three-dimensional representation of the custom building components may be adjusted and manipulated in real time or near real time. Specifically, the user may select positions of sliders, select other various menu of options, or type values into a text or dialog box via the web portal or web page described herein using the user interface 122 and/or the communication component 120. These parameters may be automatically relayed back to the database to be stored and/or updated therein. Additionally or alternatively, the user can save these user-selected parameters at any time in a user-defined file that relates to the custom building components.

In one embodiment of the invention, for customizing cloud walls, the user parameter menu 30 may comprise surface parameters 32 for configuration of the outer-most edges 22 of the fins 14; building parameters 34 for dimensions of the building 16; fin parameters 36 for height, width, spacing, and alignment of the fins, as well as a type of top extension of the fins; and material types 38 to select for the wall panel, fins, and braces. The sliders may include a selectable graphic that may be “slid” back and forth between a minimum-allowed value and a maximum-allowed value for a give parameter. Different minimum and maximum values may be provided depending on other user parameters selected. For example, a maximum degree of bend may be dependent on the material selected by the user. Similar menu options may be provided for other custom building components without departing from the scope of the invention. Specifically, if the custom building component is an image wall, the menu options may correspond to the shape being punched into a selected material, sizes and locations of the punches, and the like.

Selection of the user parameters may further include selecting a type of physical manipulations applied to the building component, quantity of physical manipulations applied to the building component, degree or dimensions of physical manipulations applied to the building component, locations of physical manipulations applied to the building component, and mounting orientation of the building component on the structural surface. In some embodiments of the invention, as illustrated in the fin parameters 36 section of the user parameter menu 30, the user-selected parameters include an amount of spacing of the fins 14 on the structural surface 12.

The method 1200 may further include the steps of applying the user-selected parameters to the selected building component, as depicted in block 1208, and displaying a visual depiction of the selected building component or components after the user-selected parameters have been applied thereto, as depicted in block 1210. For example, the user may specify that the fins 14 should each have a wave pattern or sinusoidal pattern on their outer-most edges 22, and the user may select the pitch, frequency, and/or amplitude of the sinusoidal pattern, which may then be applied to the selected building component when the user selects an “update” menu option 40. The user may also select a surface area that the fins 14 should cover and how far apart the fins 14 should be mounted, and the processing device 104 may automatically determine how many fins 14 should be used and a maximum length or width for the fins 14, depending on their selected orientation. In some embodiments of the invention, the fins 14 may be spaced laterally apart in a horizontal direction, as illustrated in FIGS. 6-11, while in other embodiments of the invention, the fins 14 may be spaced apart from each other in a vertical direction.

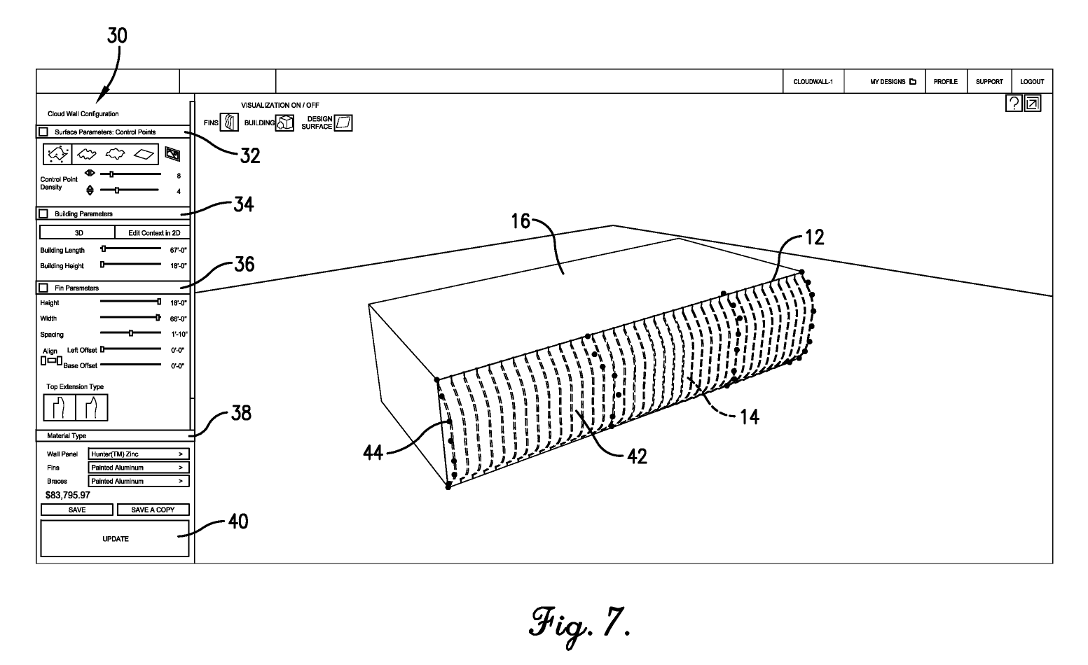

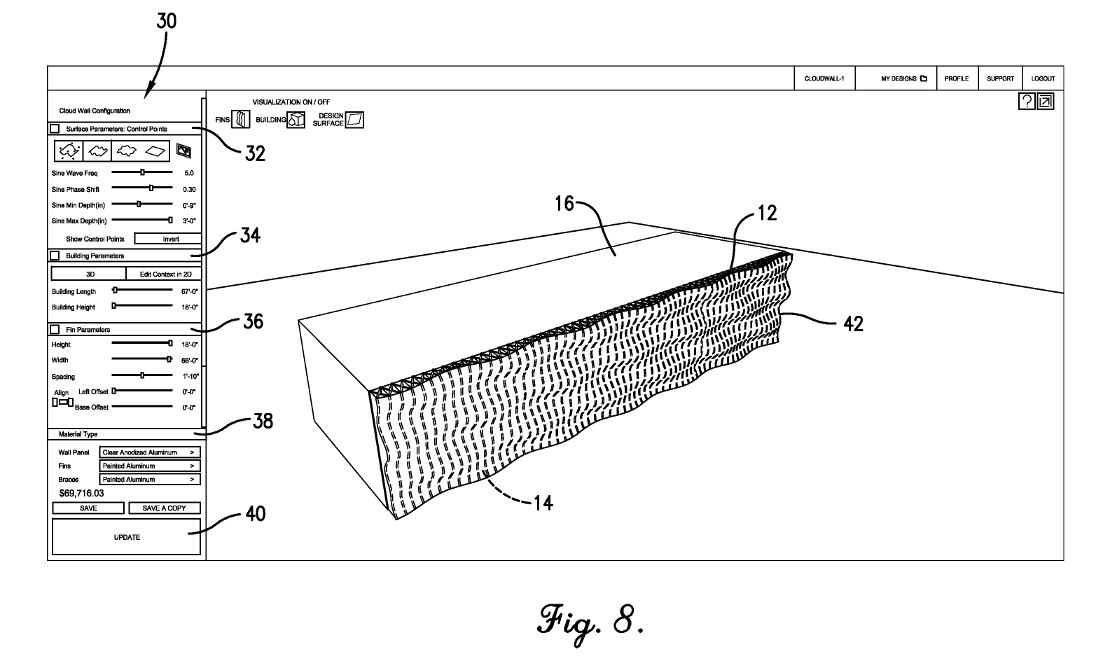

In some example embodiments of the invention, the user-selected parameters may include parameters defining shapes and curvatures of a manipulation surface 42. The manipulation surface 42 may represent a distance that the building components 10 or fins 14 perpendicularly extend from the structural surface 12 at any given point. Specifically, the different types of three-dimensional designs, such as waves or ripples, cooperatively formed by the fins 14 of the cloud wall may be visually depicted as a continuous surface by the manipulation surface 42. As illustrated in FIGS. 7 and 8, a manipulation surface 42 may be presented in the Web browser for the user to manipulate in order to achieve a desired cloud wall design.

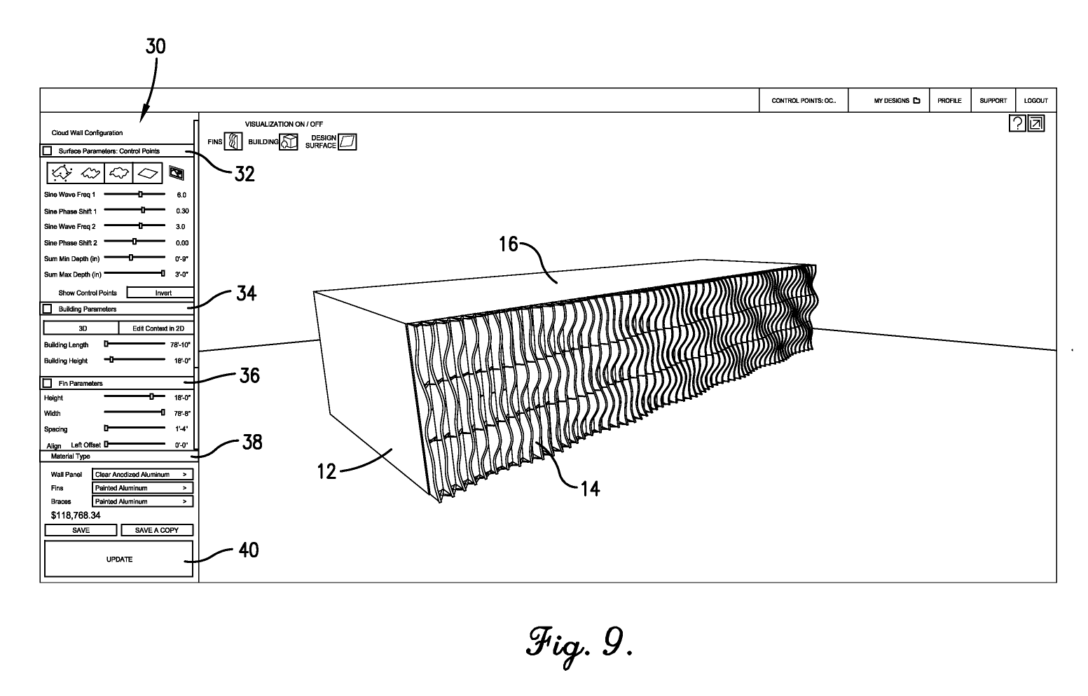

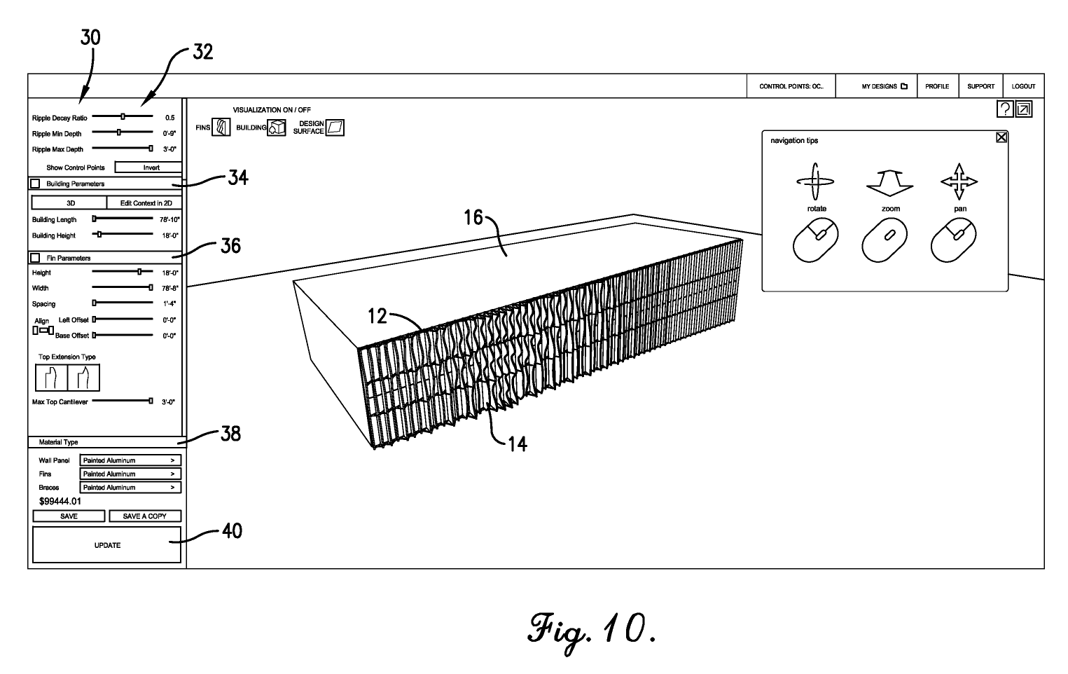

The manipulation surface 42 may be updated based on user selections made for the surface parameters 32, such as bitmap minimum and maximum depths, as illustrated in FIG. 6; control point density in a horizontal or vertical direction, as illustrated in FIG. 7; first and/or second sine wave frequency, first and/or second sine wave phase shift, sine wave maximum depth, and sine wave minimum depth, as illustrated in FIGS. 8 and 9; and ripple count, frequency, decay ratio, minimum depth and maximum depth, as illustrated in FIG. 10. Additionally, as illustrated in FIG. 7, the manipulation surface 42 may be manually manipulated using individual control points 44 when the user selects a specific one of the control points 44 and moves that control point toward or away from the structural surface 12, thereby manipulating a specific depth of curvature at that control point. However, other manipulation surfaces and parameters for the manipulation surface 42 may be utilized without departing from the scope of the invention.

Note that the visual depiction of the manipulation surface 42 may change in real time or substantially instantaneously when the user changes any of the user-selected parameters described herein, while the visual depiction of the building component or fins 14 may change after the user selects the update menu option 40. Specifically, once the manipulation surface 42 is configured according to the user's desired design, the user may select the update menu option 40, and the shapes of the series of fins 14 may be updated such that the outer-most edges 22 match the curvature of the manipulation surface 42. In various embodiments of the invention, the manipulation surface 42 does not represent a component to be manufactured and may therefore be deselected or turned off by the user to view the final cloud wall with the fins and braces as they would look after being manufactured and installed onto the structural surface 12. Additionally or alternatively, the manipulation surface 42 may be selected to be shown in a phantom mode such that the manipulation surface 42 is still visible, but the fins 14 and the structural surface 12 are also visible through the manipulation surface 42. Likewise, if the user wishes to turn off other visually-depicted elements, such as the building 16 or the fins 14, each of these components may be independently selected or deselected by the user.

In some embodiments of the invention, the manipulation surface 42 may be a three-dimensional surface generated from a two-dimensional image selected or provided by the user. For example, a menu displayed in the screen shot of FIG. 6 provides an “Upload Image” button 46 selectable by the user for providing the two-dimensional image to be used to generate the desired manipulation surface 42. After the image is uploaded, the manipulation surface 42 may be generated automatically based on characteristics of the image. Specifically, depths, dimensions, and curvatures presented in the manipulation surface 42 may be determined based on analyzing colors of the image or dark and light areas of the image. For example, lighter portions of the image may be associated with a greater height of fin and therefore a greater height of the manipulation surface 42 at those locations, while darker portions of the image may be associated with a lesser height of fin and therefore a lesser height of the manipulation surface 42, respectively.

In some embodiments of the invention, the method 1200 may include the steps of receiving from the user structural surface parameters, as depicted in block 1212, and displaying a visual depiction of the structural surface 12 with the building component of the selected type attached thereto, as depicted in step 1214. The structural surface parameters may include dimensions of the structural surface 12 or the building 16 and locations on the structural surface 12 where the building component is to be mounted. For example, the user may select how close the fins 14 are to be positioned relative to peripheral edges of the structural surface 12 and if the fins should be centered or offset left or right of a vertical center axis of the structural surface 12.

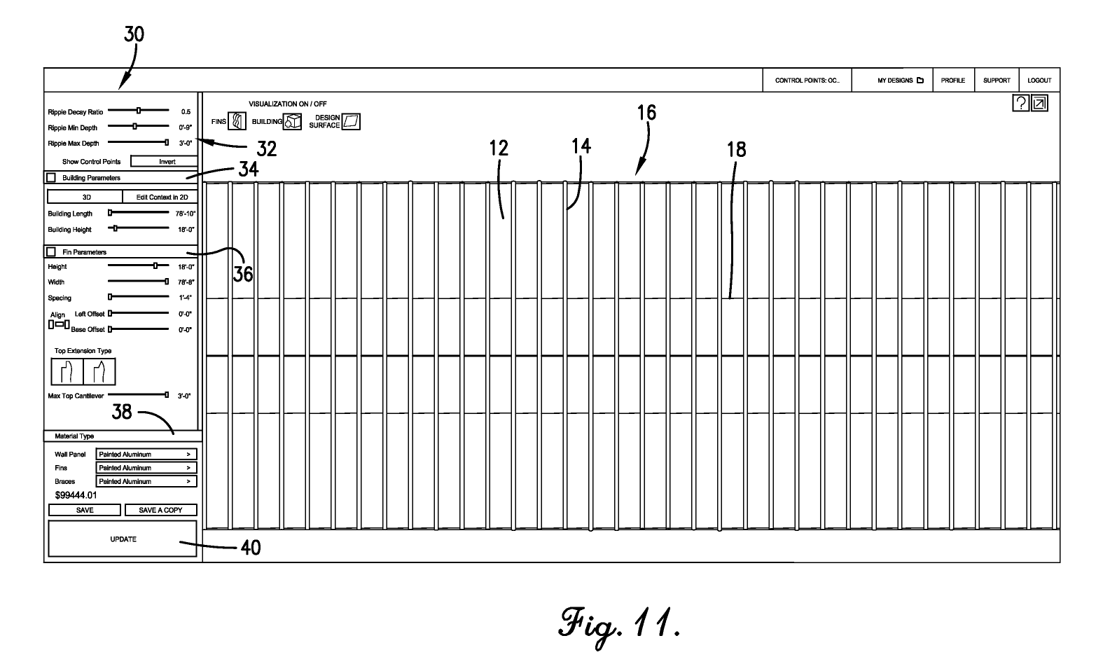

The method 1200 may also include a step of zooming, panning, or rotating the visual depiction of the selected building components, as depicted in block 1216. This may allow the design on the structural surface 12 to be viewed from many different vantage points close up or at a distance. For example, as visually depicted in FIG. 10, a plurality of manipulations of the user interface 122, such as a computer mouse, may allow the user to zoom, pan, or rotate the images shown thereby. Furthermore, the visual depiction of the selected building components may be presented in a two-dimensional view or a three-dimensional view depending on a desired view selection received from the user. For example, a menu option may be selected by the user to switch from a three-dimensional view to a two dimensional view of a visual depiction of the fins 14 mounted on the building 16, as illustrated in FIG. 11

The method 1200 may also include the steps of determining and displaying a cost of the selected building component after the user-selected parameters have been applied, as depicted in block 1218 and generating specifications for the selected building component after the user-selected parameters have been applied, as depicted in block 1220. As described above, algorithms stored in the database and/or the memory 106 may use information stored therein and user-selected parameters to calculate the cost of manufacturing and/or installing the custom building component or cloud wall. Specifically, the cost may be recalculated and updated each time the user selects the update menu option 40. The specifications may include information to manufacture the selected custom building component or cloud wall, such as a bill of materials required, engineering parameters, fabrication instructions, and installation instructions. For example, the user may select to download or otherwise view a document containing two-dimensional schematic drawings of the fins 14 and/or braces 18, including other engineering schematic notations, such as size dimensions. In some embodiments of the invention, the specifications may also include digital fabrication criteria directed to specific fabrication machines configured for manufacturing the building components or cloud wall after the user-selected parameters have been applied. The specifications may also be generated or re-generated each time the user selects the update menu option 40.

The method 1200 may also include a step of determining what braces 18 or other anchoring system components are required for structurally supporting and/or attaching the building component to the structural surface, as depicted in block 1222. The cost quote and specifications may also include information regarding quantity, materials, cost, and specifications of these braces 18 and associated anchoring system components. The braces and associated anchoring system components may be designed to support the cloud wall and/or to withstand user-defined forces. For example, the user-selected parameters may include specific types and amounts of force, specific temperatures, etc. that the cloud wall should be able to withstand. In some embodiments of the invention, the type of braces 18 and the material used for the braces 18 may be user selected, while other design specifics, such as how many braces 18 should be used and their locations relative to the fins 14 and the structural surface 12, may be calculated or otherwise determined by the processing device 104. In some embodiments of the invention, the user may select to share he specifications, bill of materials, etc. with one or more manufacturers and/or installers to receive different quotes for manufacturing and installing the custom building components or cloud wall.

The method 1200 described above may alternatively be used for other custom building components by, for example, by performing these steps on building components other than fins. Specifically, in an alternative embodiment of the invention, the system 100 and associated computer program described herein could be used to design and manufacture a table for a home. First, the user can open the computer program and enter or choose a desired height for the table. The user may also enter or choose the dimensions of the top, such as width and length, diameter, or dimensions of an oval. If the user does not want the corners to be 90 degrees, they may change the corners or a corner of the table. The algorithm or computer program may have a rule that for a rectangle, the corners must add up to 360 degrees. Alternatively, in the case of a triangular corner table, the rule used may require the corners to add up to 180 degrees, and the user may be directed to this limitation visually.

The table legs may be associated with certain rules in the database that may be evaluated quickly via the computer program. As the table grows in length, additional legs may be added and visually depicted to the user. The user may have the ability to move these additional legs within the rules established by engineering parameters in the computer program. Material options may be provided to the user, such as a selectable table top of metal or glass. The algorithm or computer program may check the data base for size limits, such as checking the width limitations or length limitations of the available raw material and placing seams as needed. The user may also adjust the seam locations within a set of rules visually displayed.

A new price for the table may be calculated and displayed based on the collection of information and the parameters of manufacture. Additionally, information such as thickness, number of fasteners, table leg pads or adjusters, amount of adhesive used to manufacture, information on the metal surface and even cleaning and maintenance information may be gathered and displayed via the computer program or algorithm, based on information in the database or accessed from other sources.

Using the computer program or algorithms, the user may collect manufacturing data for the table, a vendor supplier of raw materials may be established, and manufacturing equipment to be used may be established. Crate size and packaging information may also be determined, using information provided by the database or other data sources accessible by the computer program or system 100. Once an order is submitted by the user, the material and manufacturing data may be converted and automatically sent to a pre-established station as defined in the set of rules.

Although the invention has been described with reference to the particular embodiments, it is noted that equivalents may be employed and substitutions made herein without departing from the scope of the invention. For example, the system, computer program, and method are described herein for cloud walls and fins, but could also be used for store fronts, image walls, curtain walls, column covers, doors, and any other structural surface or facades for structural surfaces without departing from the scope of the invention. Furthermore, while the structural surface is described herein as a wall of a building, a deck, or a rail, note that the custom building components described herein could be applied to any structural surface, such as a table, ceiling, cabinet, billboard, etc., without departing from the scope of the invention. Nearly any custom designable object that can be depicted on a computer screen in three dimensions and that can be user customized to a particular size and shape, material and form, can be created using the computer system and program described herein.

Having thus described various embodiments of the invention, what is claimed as new and desired to be protected by Letters Patent includes the following:

1. A physical, non-transitory computer readable medium having a computer program stored thereon for operating a computer system for permitting a user to design custom building components to be mounted to a structural surface, the computer program comprising:
a code segment for accessing information related to building components from a database accessible by the computer system;
a code segment for receiving from the user parameters to be applied to a building component from the database;
a code segment for displaying a visual depiction of the building component as it would appear after the user-selected parameters have been applied;
a code segment for determining and displaying a cost of the building component after the user-selected parameters have been applied; and
a code segment for generating specifications for the building component, wherein the specifications include information to manufacture the building component with the user-selected parameters.

2. The computer program of claim 1, wherein the building component comprises a plurality of parts and the user-selected parameters include positioning of the parts on the structural surface.

3. The computer program of claim 1, further comprising a code segment for receiving from the user specific defining structural surface parameters and displaying a visual depiction of the structural surface, wherein the structural surface parameters include at least one of dimensions of the structural surface and locations on the structural surface where the building component is to be mounted.

4. The computer program of claim 1, wherein the user-selected parameters include at least one of material from which the building component will be made, dimensions of the building component, type of physical manipulations applied to the building-component, quantity of physical manipulations applied to the building component, degree or dimensions of physical manipulations applied to the building component, locations of physical manipulations applied to the building component, and mounting orientation of the building component on the structural surface.

5. The computer program of claim 1, further comprising a code segment for determining what anchoring system components are required for structurally supporting or attaching the building component to the structural surface, wherein the cost quote and specifications include information regarding quantity, materials, cost, and specifications of the anchoring system components.

6. The computer program of claim 1, wherein the specifications include at least one of engineering parameters, fabrication instructions, and installation instructions.

7. The computer program of claim 1, wherein the specifications include digital fabrication criteria directed to specific fabrication machines configured for manufacturing the building component with the user-selected parameters.

8. The computer program of claim 1, wherein the visual depiction of the building component is presented in a two-dimensional view or a three-dimensional view depending on a desired view selection received from the user.

9. The computer program of claim 1, further comprising a code segment for zooming, panning, or rotating the visual depiction of the building component.

10. The computer program of claim 1, wherein information in the database comprises materials, prices for particular materials, information regarding prices for particular types of manipulation performed on each of the materials, and algorithms for using the user-selected parameters and the information stored in the database to calculate the cost of the building component.

11. A physical, non-transitory computer readable medium having a computer program stored thereon for operating a computer system for permitting a user to design custom building components to be mounted to a structural surface, the computer program comprising:
a code segment for accessing information related to building components from a database accessible by the computer system;
a code segment for receiving from the user a selection of a type of building component from the database to customize;
a code segment for receiving structural surface parameters from the user;
a code segment for receiving user-selected parameters from the user to be applied to a plurality of building components of the selected type;
a code segment for displaying a visual depiction of the building components with the user-selected parameters and attached to the structural surface;
a code segment for determining and displaying a cost of the building components having the user-selected parameters applied thereto; and
a code segment for generating specifications for the building components having the user-selected parameters applied thereto, wherein the specifications include information to fabricate the building component.

12. The computer program of claim 11, wherein the structural surface parameters include at least one of dimensions of the structural surface and locations on the structural surface where the building components are to be mounted, wherein the user-selected parameters include at least one of material from which the building components will be made, dimensions of the building components, type of physical manipulations applied to the building components, quantity of physical manipulations applied to the building components, degree or dimensions of physical manipulations applied to the building components, locations of physical manipulations applied to the building components, spacing of the building components on the structural surface, and mounting orientation of the building components on the structural surface.

13. The computer program of claim 11, further comprising a code segment for determining a type, location, and quantity of braces required for attaching the building components having the user-selected parameters to the structural surface, wherein the cost quote and specifications include information regarding the braces.

14. The computer program of claim 11, wherein the specifications include at least one of engineering parameters, fabrication instructions, installation instructions, and digital fabrication criteria directed to specific fabrication machines configured for manufacturing the building components having the user-selected parameters.

15. The computer program of claim 11, wherein the user-selected parameters include parameters defining shapes and curvatures of a manipulation surface, wherein the manipulation surface represents a distance that the building components extend from the structural surface at any given point.

16. The computer program of claim 16, wherein the manipulation surface is a three-dimensional surface generated from a two-dimensional image selected or provided by the user.

17. The computer program of claim 11, wherein the building components are a series of fins cooperatively forming a cloud wall on the structural surface.

18. A computer-implemented method for operating a computer system for permitting a user to design custom building components to be mounted to a structural surface, the method comprising:
accessing, with the computer system, information related to building components from a database;
receiving from the user, with the computer system, a selection of a type of building component from the database to customize or a selection of a previously-designed configuration of custom building components to edit;
receiving, with the computer system, structural surface parameters from the user;
receiving, with the computer system, user-selected parameters from the user to be applied to a plurality of building components of the selected type or to be applied to the custom building components of the previously-designed configuration;
displaying, with the computer system, a visual depiction of the building components, with the user-selected parameters applied thereto, attached to the structural surface;
determining and displaying, with the computer system, a cost of the building components with the user-selected parameters applied thereto;
generating, with the computer system, specifications for the building components having the user-selected parameters, wherein the specifications include information to fabricate and install the building component; and
determining, with the computer system, a type, location, and quantity of braces required for attaching the building components having the user-selected parameters to the structural surface, wherein the cost quote and specifications include information regarding the braces.

19. The method of claim 18, wherein the structural surface parameters include at least one of dimensions of the structural surface and locations on the structural surface where the building components are to be mounted, wherein the user-selected parameters include at least one of material from which the building components will be made, dimensions of the building components, type of physical manipulations applied to the building components, quantity of physical manipulations applied to the building components, degree or dimensions of physical manipulations applied to the building components, locations of physical manipulations applied to the building components, spacing of the building components on the structural surface, and mounting orientation of the building components on the structural surface.

20. The method of claim 18, wherein the user-selected parameters include parameters defining shapes and curvatures of a manipulation surface, wherein the manipulation surface represents a distance that the building materials perpendicularly extend from the structural surface at any given point.
